(19) United States
(12) Patent Application Publication
(10) Pub. No.: US 2026/0254914 A1
(43) Pub. Date: Aug. 27, 2026

(54) METHOD AND SYSTEM FOR CALCULATING COLOR FASTNESS OF TEXTILE METHOD

(71) Applicant: Dongguan Fengzhen Testing Equipment Co., Ltd., Dongguan (CN)

(72) Inventor: Xumin Wu, Dongguan (CN)

(21) Appl. No.: 19/540,527

(22) Filed: Feb. 13, 2026

(30) Foreign Application Priority Data
Feb. 26, 2025 (CN) 202510217615.8

(51) Int. Cl. H04N 1/60; H04N 1/52

(52) U.S. Cl. CPC H04N 1/6022; H04N 1/52; H04N 1/6027; H04N 1/6033; H04N 1/6086; G06T 2207/10024

(57) ABSTRACT

A method for calculating color fastness of a textile includes obtaining gray value ratios between a gray region and a light-color region in each pair of reference color cards in a standard gray scale for staining, thereby obtaining a plurality of standard gray scale ratios; generating a plurality of the quantization intervals respectively corresponding to each color fastness level based on the standard gray scale ratios; obtaining a gray value ratio between a dyed region and an undyed region of the textile to the quantization value; and assigning a color fastness level to the textile by determining into which quantization interval the quantization value falls. The method can effectively improve the efficiency and accuracy of color fastness evaluation.

### CROSS-REFERENCE TO RELATED APPLICATION

The present application claims priority from Chinese Patent Application No. 202510217615.8 filed on Feb. 26, 2025, the contents of which are incorporated herein by reference in their entirety.

### FIELD OF THE INVENTION

The present disclosure relates to the field of image processing technology, and particularly to a method for generating calculation parameters of color fastness of a textile, a method and a system for calculating color fastness of a textile.

### BACKGROUND OF THE INVENTION

With the rapid development of the textile industry, the evaluation of color fastness of textiles has become a crucial step in ensuring product quality. Color fastness refers to the ability of textiles to retain the color when subjected to various environmental factors during use, such as washing, rubbing, and light exposure. Currently, evaluation methods of the color fastness primarily include a visual evaluation and an instrumental evaluation.

The traditional visual evaluation relies mainly on experienced personnel who perform color deviation comparisons by eye, i.e., matching the stained textile to be evaluated against each pair of reference color cards in a standard gray scale for staining to rate the color fastness level. Such an evaluation is straightforward, but its drawbacks are significant. Firstly, the visual evaluation is labor-intensive, which easily brings visual fatigue for the evaluators to reduce the accuracy of the results when facing a large number of samples. Secondly, the visual evaluation is highly subjective, which may cause that the evaluation results often exhibit considerable variation due to differences in human visual perception and individual sensitivity to color. Therefore, visual evaluation imposes high demands on the evaluator's expertise and experience.

To address the limitations of visual evaluation, instrumental evaluation has emerged. Currently, a common instrumental evaluation includes spectrophotometry and photoelectric integration. Instrumental evaluation utilizes advanced technological means to eliminate human interference from measurement results, typically yielding more stable and precise outcomes. However, studies have shown that even theoretically more reliable instrumental evaluations can still exhibit significant deviations compared to traditional visual evaluations. Such deviations often relegate instrumental results to a secondary, reference-only role in commercial practice.

In summary, existing methods for evaluating color fastness each exhibit intrinsic limitations. There remains an unmet need for a novel evaluation method that combines the benefits of subjective human evaluation with objective instrumental evaluation.

### SUMMARY OF THE INVENTION

An object of the present disclosure is to provide a method for generating calculation parameters of color fastness of a textile, a method and a system for calculating color fastness of a textile, to effectively improve the efficiency and accuracy of color fastness evaluation. To achieve the above object, the present disclosure provides a method for generating calculation parameters of color fastness of a textile, the calculation parameters comprising quantization intervals and a quantization value. The method includes: obtaining gray value ratios between a gray region and a light-color region in each pair of reference color cards in a standard gray scale for staining, thereby obtaining a plurality of standard gray scale ratios; wherein the light-color region corresponds to a color of the textile before dyed, and the gray region corresponds to a color of the textile after dyed; generating a plurality of the quantization intervals respectively corresponding to each color fastness level based on the standard gray scale ratios respectively corresponding to each pair of the reference color cards; and obtaining a gray value ratio between a dyed region and an undyed region of the textile to obtain the quantization value.

As a preferred embodiment, the quantization intervals are generated by: ranking the standard gray scale ratios in ascending or descending order of the color fastness levels represented by the reference color cards in the standard gray scale for staining, thereby obtaining a ratio array; averaging two adjacent standard gray scale ratios in the ratio array, thereby obtaining quantization boundary values; and defining numerical intervals formed by each of the quantization boundary values on a numerical axis as the quantization intervals.

As a preferred embodiment, the standard gray scale ratios are generated by: capturing a first image of the standard gray scale for staining under a standard light source; performing image recognition processing on the first image with an image processor to obtain a first gray value corresponding to the gray region and a second gray value corresponding to the light-color region in each pair of the reference color cards; and dividing the first gray value by the second gray value to yield the standard gray scale ratio.

As a preferred embodiment, the quantization value is generated by: capturing a second image of the dyed region and the undyed region of the textile under the standard light source; performing image recognition processing on the second image with the image processor to obtain a third gray value corresponding to the dyed region and a fourth gray value corresponding to the undyed region; and dividing the third gray value by the fourth gray value to yield the quantization value.

As a preferred embodiment, when used for calculating rubbing color fastness of the textile, the third gray value and the fourth gray value are obtained by: converting the second image into a grayscale image; applying a contour recognition algorithm to delineate a boundary of the dyed region in the grayscale image to obtain a first image block related to a dyed contour, and randomly selecting at least one second image block adjacent to but outside the first image block and having substantially the same area as the first image block; averaging gray values of a plurality of pixels in the first image block to obtain the third gray value; and averaging gray values of a plurality of pixels in the second image block to obtain the fourth gray value.

As a preferred embodiment, the method further includes a first verification procedure for verifying a current the second image: constructing a circumscribed circle and an inscribed circle for the first image block based on a contour of the first image block; calculating a radius ratio of the inscribed circle to the circumscribed circle to obtain a roundness value of the first image block; and determining whether the current the second image is valid by comparing the roundness value with a preset roundness threshold.

As a preferred embodiment, the method further includes a second verification procedure for verifying a current the second image: calculating a color uniformity Cu of the second image block based on the following formula:

$$Cu = \frac{A - std ( gra y )}{avg ( gray )} * 100 \%$$

wherein A is a constant set based on a magnitude of gray values, std(gray) is a standard deviation of gray values of the first image block, and avg(gray) is an average gray value of the first image block; and determining whether the current the second image is valid by comparing the color uniformity with a preset uniformity threshold.

The present disclosure further provides a method for calculating color fastness of a textile, including: generating the quantization intervals and the quantization value based on the method mentioned above; and assigning a color fastness level to the textile by determining into which quantization interval the quantization value falls.

The present disclosure further provides a system for calculating color fastness of a textile, including: an image acquisition module, configured to capture images of a standard gray scale for staining and a stained textile; a parameter generation module, configured to process the images based on the method mentioned above to generate the quantization intervals and the quantization value; and a comparison module, configured to match the quantization value to the quantization intervals to output a color fastness level for the stained textile.

The present disclosure further provides a system for calculating color fastness of a textile, including: one or more processors; a memory; and one or more programs stored in the memory and configured to be executed by the one or more processors, the programs comprising instructions for executing the method mentioned above.

The present disclosure further provides a non-transitory computer-readable storage medium, including a computer program which is executable by a processor to perform the method mentioned above.

Compared with the prior art, the method for calculating color fastness of a textile provided by the present disclosure firstly obtains gray value ratios corresponding to the standard gray scale, as well as quantization values corresponding to the textile to be evaluated, and then automatically generates a color fastness level by mapping a quantization value into the quantization interval. By this token, the evaluation method of the color fastness is standardized, and the influence of subjective human assessment is reduced, thereby enhancing the objectivity and consistency of color fastness evaluation. Furthermore, this approach not only lowers labor intensity but also improves the efficiency of color fastness evaluation, enabling the processing of a large number of samples within a short period of time, thereby satisfying modern industrial mass-production requirements.

### BRIEF DESCRIPTION OF THE DRAWINGS

FIG. 1 is a flowchart illustrating a method for calculating color fastness of a textile according to an embodiment of the present disclosure.

FIG. 2 is a flowchart illustrating a method for generating quantization intervals according to an embodiment of the present disclosure.

FIG. 3 illustrates a sample image of a stained textile to be evaluated for rubbing color fastness according to an embodiment of the present disclosure.

FIG. 4 illustrates a sample image of a stained textile to be evaluated according to an embodiment of the present disclosure.

### DETAILED DESCRIPTION OF ILLUSTRATED EMBODIMENTS

In order to elaborate on the technical contents, structural features, objectives, and effects achieved by the present disclosure, the following description is provided in conjunction with embodiments and drawings for detailed explanation.

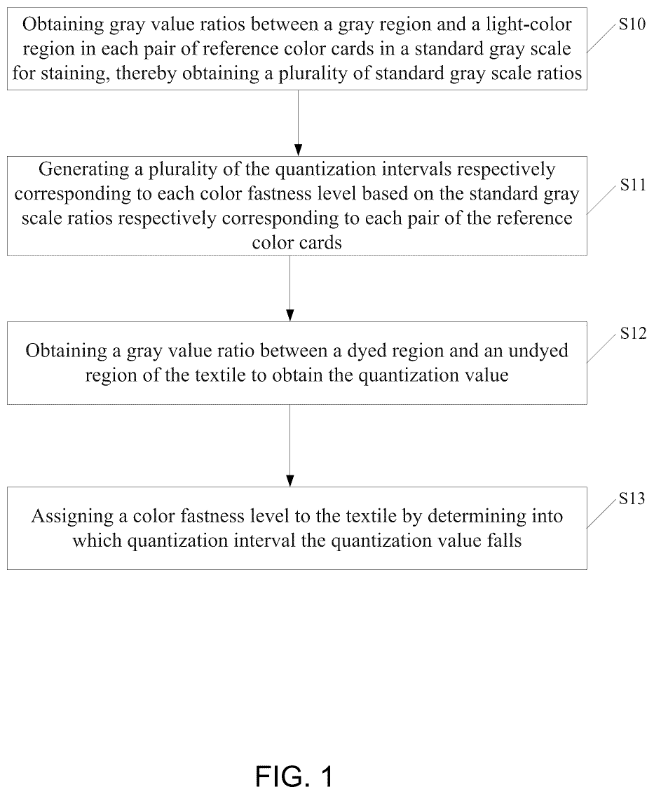

The present embodiment discloses a method for calculating color fastness of a textile based on machine vision for automatically and batch-wise evaluating the color fastness of textiles. The method relies on two calculation parameters—quantization intervals and a quantization value—to perform the automatic evaluation. Referring to FIG. 1, the method for calculating color fastness of textiles is shown.

At S10, gray value ratios between a gray region and a light-color region in each pair of reference color cards within a standard gray scale for staining are obtained, so as to obtain a plurality of standard gray scale ratios. The light-color region corresponds to the color of the textile before dyed, and the gray region corresponds to the color of the textile after dyed.

It should be noted that the standard gray scale for staining in the present embodiment is a tool conventionally used for visual evaluation of the degree of staining on adjacent fabric or undyed textiles after color fastness testing.

The gray scale for staining consists of multiple pairs of reference color cards, each pair including a white card and a gray card, each pair representing a specific degree of color deviation or contrast (color and intensity), and corresponding to a specific staining level denoted by a number. On the gray scale, the color fastness levels and their corresponding color deviations and tolerances are determined based on the following formula: CIE L*a*b* (CIELAB). Specifically, a color fastness level of 5 is represented by a reference pair consisting of two identical reference white cards placed side by side, each having a reflectance of not less than 85%.

Specifically, the color fastness levels include nine levels: Level 1, Level 1/2, Level 2, Level 2/3, Level 3, Level 3/4, Level 4, Level 4/5, and Level 5. In the gray scale for staining, one pair of reference color cards represents one grade; consequently the gray scale contains nine pairs of reference color cards.

At S11, a plurality of quantization intervals respectively corresponding to each color fastness level is generated based on a plurality of the standard gray scale ratios respectively corresponding to each pair of reference color cards. The number of quantization intervals is equal to the number of color fastness levels in the standard gray scale for staining.

At S12, a gray value ratio between a dyed region and an undyed region of the textile is obtained, so as to obtain the quantization value.

At S13, a color fastness level is assigned to the current stained textile by determining into which quantization interval the quantization value falls.

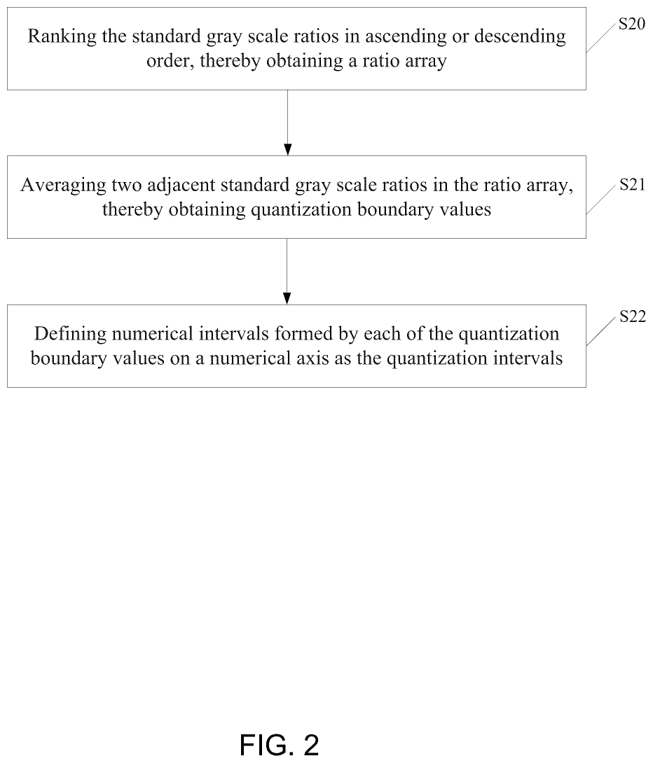

As an embodiment, as shown in FIG. 2 and Table 1 below, the method for generating quantization intervals follows.

At S20, the standard gray scale ratios are ranked in ascending or descending order of the color fastness levels represented by each reference color card in the standard gray scale for staining, thereby obtaining a ratio array which includes a plurality of standard gray scale ratios.

At S21, each pair of adjacent standard gray scale ratios in the ratio array is averaged, thereby obtaining quantization boundary values.

At S22, the numerical intervals formed by each of the quantization boundary values on a numerical axis are defined as the quantization intervals.

TABLE 1

| | Reference | Standard | | |
|---|---|---|---|---|
| | Color Card | Gray Scale | Quantization | Quantization |
| Level (L) | No. | Ratio (R) | Boundary Value | Interval |
| L1 = 1 | No. 1 | R1 = 0.37 | (R1 + R2)/2 = 0.440 | [0.000, 0.440] |
| L2 = 1/2 | No. 2 | R2 = 0.51 | (R2 + R3)/2 = 0.570 | (0.440, 0.570] |
| L3 = 2 | No. 3 | R3 = 0.63 | (R3 + R4)/2 = 0.675 | (0.570, 0.675] |
| L4 = 2/3 | No. 4 | R4 = 0.72 | (R4 + R5)/2 = 0.755 | (0.675, 0.755] |
| L5 = 3 | No. 5 | R5 = 0.79 | (R5 + R6)/2 = 0.820 | (0.755, 0.820] |
| L6 = 3/4 | No. 6 | R6 = 0.85 | (R6 + R7)/2 = 0.880 | (0.820, 0.880] |
| L7 = 4 | No. 7 | R7 = 0.91 | (R7 + R8)/2 = 0.935 | (0.880, 0.935] |
| L8 = 4/5 | No. 8 | R8 = 0.96 | (R8 + R9)/2 = 0.970 | (0.935, 0.970] |
| L9 = 5 | No. 9 | R9 = 0.98 | | (0.970, 1.000] |

For example, for a textile to be evaluated, the quantization value representing the gray value ratio between its dyed region and undyed region is 0.2 which falls within the quantization interval [0.000, 0.440], indicating that the color fastness level of this textile is 1. For another example, the quantization value is 0.7 which falls within the quantization interval (0.675, 0.755], indicating that the color fastness level of this textile is ⅔.

As an embodiment, the method for generating standard gray scale ratios includes: capturing a first image of the standard gray scale for staining under a standard light source; performing image recognition processing on the first image with an image processor to obtain a first gray value corresponding to the gray region and a second gray value corresponding to the light-color region in each pair of the reference color cards; and dividing the first gray value by the second gray value to yield the standard gray scale ratio.

Similarly, the method for generating the quantization value includes: capturing a second image of the dyed region and the undyed region of the textile under the standard light source; performing image recognition processing on the second image with the image processor to obtain a third gray value corresponding to the dyed region and a fourth gray value corresponding to the undyed region; and dividing the third gray value by the fourth gray value to yield the quantization value.

Specifically in the present embodiment, a cubic light booth having an N7 gray interior is employed; two D65 fluorescent tubes (VeriVide) and an industrial camera are installed inside the top panel. The plane of the object to be measured is positioned approximately 300 mm below the lens. The tubes are driven by a constant current source at a color temperature of about 6500K and an illuminance of 1250 lx. The textile or standard gray scale for staining is laid flat parallel to the booth top and bottom. Images captured by the camera are transmitted via a USB to a PC which then performs all subsequent color fastness detection and calculation.

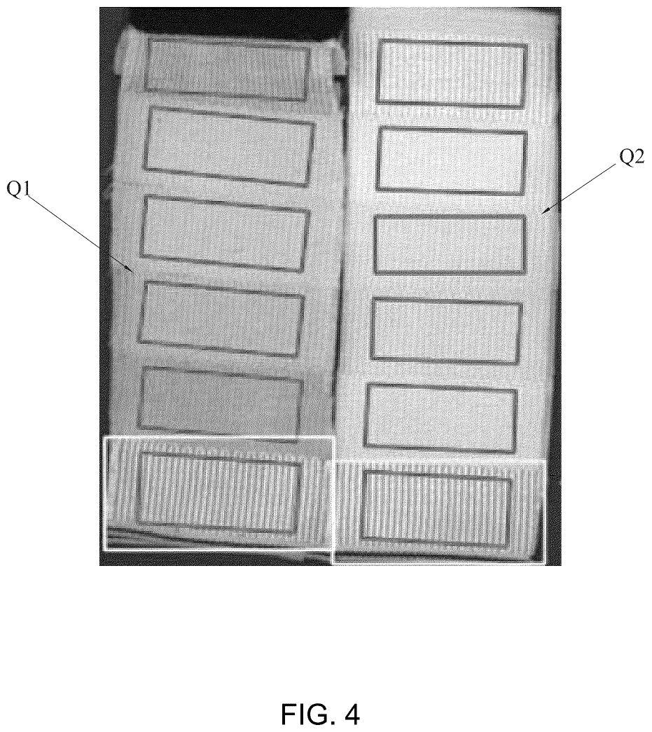

When the method is applied to washing color fastness calculation of textiles, as shown in FIG. 4, the dyed region Q1 and the undyed region Q2 lie on two separate fabric pieces. In this case, a patch (square, circular, or other shapes) is extracted from each fabric piece, to calculate their respective gray values.

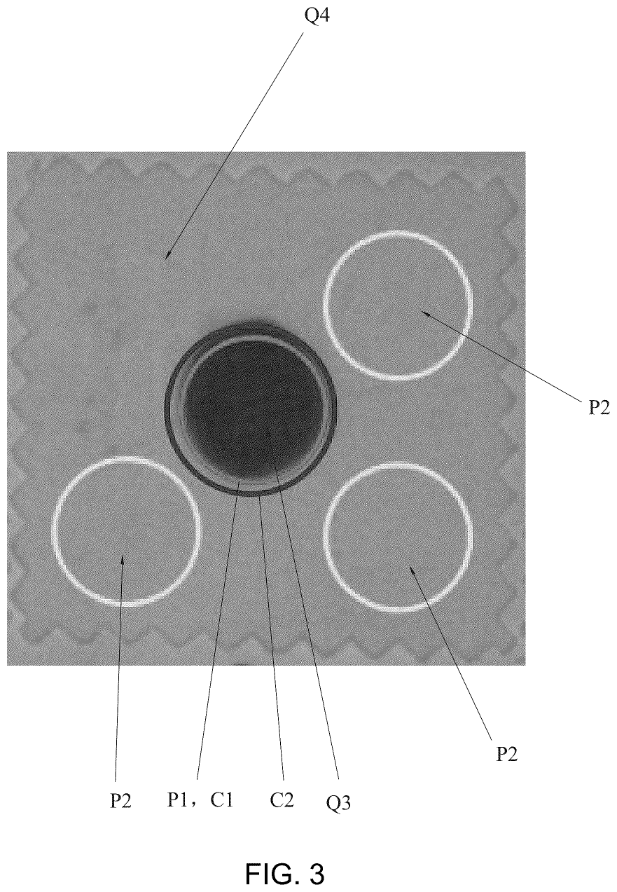

As an embodiment, when the method is applied to rubbing color fastness calculation of textiles, the stained textile sample to be evaluated is a fabric piece that has been rubbed. As shown in FIG. 3, the dyed region Q3 and the undyed region Q4 lie on the same fabric piece. The dyed region Q3 is positioned at the center of the fabric piece, and the undyed region Q4 is located peripheral to the dyed region Q3. In this case the method for obtaining the third gray value and the fourth gray value includes: converting the second image to a grayscale image; applying a contour recognition algorithm to delineate the boundary of the dyed region Q3 in the grayscale image, thereby obtaining a first image block P1 related to the dye contour C; and randomly selecting at least one second image block P2 adjacent to but outside P1 and having substantially the same area as P1. It should be noted that a contour recognition algorithm is a conventional digital image processing algorithm used to extract the outer boundary of a target object from binarized, edge-detected, or thresholded images. The detailed algorithms—connectivity-based, edge-based, or segmentation-based—are well known and need not be reiterated.

The method for obtaining the third gray value and the fourth gray value further includes averaging the gray values of a plurality of pixels in the first image block P1 to obtain the third gray value and averaging the gray values of a plurality of pixels in the second image block P2 to obtain the fourth gray value.

As an embodiment, to ensure the validity of the sample represented by the second image, the method further includes a first verification procedure for the current second image: constructing a circumscribed circle C2 and an inscribed circle C1 for the first image block P1 based on the contour of the first image block P1; calculating a ratio of the radius of the inscribed circle C1 to that of the circumscribed circle C2, thereby obtaining a roundness value of the first image block P1; and determining whether the current second image is valid by comparing the roundness value with a preset roundness threshold.

Specifically, the second image is rejected as invalid if the roundness value of the first image block P1 is below the preset roundness threshold. In such a way, the accuracy of the generated color fastness level is ensured.

A second verification procedure may additionally or alternatively be executed, by calculating a color uniformity Cu for the second image block P2 according to the following formula:

$$Cu = \frac{A - std ( gra y )}{avg ( gray )} * 100 \%$$

where A is a constant set based on the magnitude of the gray values, std(gray) is a standard deviation of the gray values of the first image block P1, and avg(gray) is an average gray value of the first image block P1.

By comparing the color uniformity and a preset uniformity threshold, it's determined whether the current second image is valid. That is, the current second image will be rejected if the color uniformity Cu falls below the preset uniformity threshold.

Thus, the validity may be assessed by roundness, uniformity, or both; upon invalidity, calculation is aborted and an alert is issued.

In summary, the method for calculating color fastness of a textile provided by the present disclosure firstly obtains gray value ratios corresponding to the standard gray scale, as well as quantization values corresponding to the textile to be evaluated, and then automatically generates a color fastness level by mapping a quantization value into the quantization interval. By this token, the evaluation method of the color fastness is standardized, and the influence of subjective human assessment is reduced, thereby enhancing the objectivity and consistency of color fastness evaluation. Furthermore, this approach not only lowers labor intensity but also improves the efficiency of color fastness evaluation, enabling the processing of a large number of samples within a short period of time, thereby satisfying modern industrial mass-production requirements.

In another preferred embodiment of the present disclosure, a system for calculating color fastness of a textile is further disclosed. The system includes an image acquisition module for capturing images of the standard gray scale and of the stained textile, a parameter generation module for executing the above-described method to produce quantization intervals and the quantization value, and a comparison module for matching the quantization value to the quantization intervals and outputting the corresponding color fastness level.

The operation of the system in the present embodiment is identical to the aforementioned method and will not be repeated here.

The present disclosure further discloses another system for calculating color fastness of a textile, including one or more processors, a memory, and one or more programs stored in the memory and configured to be executed by the one or more processors. The programs include instructions for executing the textile color fastness calculation method as described above. The processor(s) may be a general-purpose Central Processing Unit (CPU), a microprocessor, an Application Specific Integrated Circuit (ASIC), or one or more integrated circuits, configured to execute relevant programs to implement the functions required by the modules in the system, or to execute the methods of the present disclosure.

The present disclosure further discloses a non-transitory computer-readable storage medium comprising a computer program. The computer program is executable by a processor to complete the methods as described above. The non-transitory computer-readable storage medium may be any medium accessible by a computer or a data storage device such as a server or data center integrating one or more available media. The medium may be read-only memory (ROM), random access memory (RAM), magnetic media (e.g., floppy disk, hard disk, magnetic tape, magnetic disk), optical media (e.g., digital versatile disc, DVD), or semiconductor media (e.g., solid-state drive, SSD), etc.

The present disclosure further discloses a computer program product or computer program comprising computer instructions stored in a non-transitory computer-readable storage medium. A processor of an electronic device is configured to read the computer instructions from the non-transitory computer-readable storage medium and execute the computer instructions, causing the electronic device to perform the aforementioned textile color fastness calculation method.

The foregoing descriptions are merely specific preferred embodiments of the present disclosure, but the protection scope of the present disclosure is not limited thereto. Any modification or substitution readily conceivable by a person skilled in the art within the technical scope disclosed by the present disclosure shall fall within the protection scope of the present disclosure. Therefore, the protection scope of the present disclosure shall be subject to the protection scope defined by the claims.

What is claimed is:

1. A method for generating calculation parameters of color fastness of a textile, the calculation parameters comprising quantization intervals and a quantization value, and the method comprising:
obtaining gray value ratios between a gray region and a light-color region in each pair of reference color cards in a standard gray scale for staining, thereby obtaining a plurality of standard gray scale ratios; wherein the light-color region corresponds to a color of the textile before dyed, and the gray region corresponds to a color of the textile after dyed;
generating a plurality of the quantization intervals respectively corresponding to each color fastness level based on the standard gray scale ratios respectively corresponding to each pair of the reference color cards; and
obtaining a gray value ratio between a dyed region and an undyed region of the textile to obtain the quantization value.

2. The method according to claim 1, wherein the quantization intervals are generated by:
ranking the standard gray scale ratios in ascending or descending order of the color fastness levels represented by the reference color cards in the standard gray scale for staining, thereby obtaining a ratio array;
averaging two adjacent standard gray scale ratios in the ratio array, thereby obtaining quantization boundary values; and
defining numerical intervals formed by each of the quantization boundary values on a numerical axis as the quantization intervals.

3. The method according to claim 1, wherein the standard gray scale ratios and the quantization value are generated by:
capturing a first image of the standard gray scale for staining under a standard light source;
performing image recognition processing on the first image with an image processor to obtain a first gray value corresponding to the gray region and a second gray value corresponding to the light-color region in each pair of the reference color cards;
dividing the first gray value by the second gray value to yield the standard gray scale ratio;
capturing a second image of the dyed region and the undyed region of the textile under the standard light source;
performing image recognition processing on the second image with the image processor to obtain a third gray value corresponding to the dyed region and a fourth gray value corresponding to the undyed region; and
dividing the third gray value by the fourth gray value to yield the quantization value.

4. The method according to claim 3, wherein, when used for calculating rubbing color fastness of the textile, the third gray value and the fourth gray value are obtained by:
converting the second image into a grayscale image;
applying a contour recognition algorithm to delineate a boundary of the dyed region in the grayscale image to obtain a first image block related to a dyed contour, and randomly selecting at least one second image block adjacent to but outside the first image block and having substantially the same area as the first image block;
averaging gray values of a plurality of pixels in the first image block to obtain the third gray value; and
averaging gray values of a plurality of pixels in the second image block to obtain the fourth gray value.

5. The method according to claim 4, further comprising a first verification procedure for verifying a current the second image:
constructing a circumscribed circle and an inscribed circle for the first image block based on a contour of the first image block;
calculating a radius ratio of the inscribed circle to the circumscribed circle to obtain a roundness value of the first image block; and
determining whether the current the second image is valid by comparing the roundness value with a preset roundness threshold.

6. The method according to claim 4, further comprising a second verification procedure for verifying a current the second image:
calculating a color uniformity Cu of the second image block based on the following formula:
$$Cu = \frac{A - std ( gra y )}{avg ( gray )} * 100 \%$$
wherein A is a constant set based on a magnitude of gray values, std(gray) is a standard deviation of gray values of the first image block, and avg(gray) is an average gray value of the first image block; and
determining whether the current the second image is valid by comparing the color uniformity with a preset uniformity threshold.

7. A method for calculating color fastness of a textile, comprising:
generating the quantization intervals and the quantization value based on the method according to claim 1; and
assigning a color fastness level to the textile by determining into which quantization interval the quantization value falls.

8. A system for calculating color fastness of a textile, comprising:
one or more processors;
a memory; and
one or more programs, wherein the one or more programs are stored in the memory and configured to be executed by the one or more processors, the programs comprising instructions for executing the method according to claim 7.
